(19) United States
(12) Patent Application Publication
(10) Pub. No.: US 2010/0124875 A1
(43) Pub. Date: May 20, 2010

(54) MOVABLE AIR EXHAUST DEVICE FOR AN AIRCRAFT

(75) Inventors: Thomas Stevens, Tournefeuille (FR); Olivier Barbara, Puylaurens (FR)

Correspondence Address: YOUNG & THOMPSON, 209 Madison Street, Suite 500, Alexandria, VA, 22314, US

(73) Assignee: AIRBUS FRANCE, Toulouse (FR)

(21) Appl. No.: 12/598,795

(22) PCT Filed: Apr. 28, 2008
(86) PCT No.: PCT/FR08/50763

§ 371 Date: Nov. 4, 2009

(30) Foreign Application Priority Data
May 4, 2007 (FR) 07 54874

(51) Int. Cl. B64D 13/00

(52) U.S. Cl. 454/76

(57) ABSTRACT

An air exhaust device is equipped with a grid (10) that is connected to an aerodynamic surface of an aircraft, whereby the grid includes a number of openings that are delimited by separating zones that are arranged in the extension of the aerodynamic surface of the aircraft, whereby the device and the grid are characterized by a surface that makes possible the passage of the air called passage surface, characterized in that it includes at least one movable part so as to increase the passage surface of the device, in particular in the case of a malfunction, and in that the grid (10) has a passage surface that is determined as a function of the flow rate of air that is to be evacuated under the most restrictive conditions of a normal flight, in the absence of a malfunction.

This invention relates to a movable air exhaust device for an aircraft that is more particularly designed to be used on an aerodynamic surface that is able to be in contact with the air flows that flow outside of said aircraft.

An aircraft is generally equipped with air systems, in particular to ensure heating, cooling or ventilation, comprising circuits that extend from at least one air intake up to at least one air exhaust by passing through exchangers or any other device that requires air or that operates with air.

As appropriate, these air intakes and exhausts are located on the surface of the fuselage, the wing, a nacelle, or a mast, and more generally on the aerodynamic surface of the aircraft.

These air systems inevitably induce a parasitic drag that originates from, for example, surface defects that are linked to the implantation of the intake or exhaust at the surface that is in contact with the outside air flow, due to the energy difference of the air flow between the intake and the exhaust of the system or due to possible broadening of the aerodynamic shapes produced by installation constraints of the system.

To meet the expectations of clients, however, the aircraft manufacturers seek to improve the aerodynamics of their equipment so as to reduce their operating costs that are strongly linked to fuel consumption.

To attain this objective, the best solution that relates to an air system consists in optimizing the differential heads of the overall air system.

The purpose of this application is to optimize a portion of the air system, namely an air exhaust device.

An air exhaust device influences the aerodynamics of the aircraft due to the parasitic drag generated when it does not produce any air that originates from the surface defect or when it produces the air that results from the disturbance of the outside air flow.

Furthermore, the differential heads undergone by the air flow of the system during its passage through the air exhaust also influence the aerodynamics of the aircraft.

To compensate for these negative influences, an attempt is made to recover the thrust that is provided to the aircraft by the air exhaust when air circulation exists in the system. In this sense, the ideal is to eject the air in the direction of the outside air flow, with a high ejection rate so as to maximize the thrust force modulus.

According to the prior art, there are two large families of air exhausts.

The first family of dynamic-type exhausts comprises a bulge at the air exhaust, with an exhaust that is oriented toward the rear of the aircraft.

This configuration makes it possible to reduce the differential heads to the extent that the exhaust protects the air of the system from the outside air flow by guiding it gradually in the direction of said outside air flow, which also contributes to maximizing the recovery of the thrust produced by the exiting air. This configuration, however, creates a considerable surface defect that produces a significant parasitic drag.

Consequently, this solution is recommended when the energy of the flow exiting from the system is higher than that of the flow of the outside air, in particular when the advantages that are derived from the recovery of the thrust generated by the exiting air compensate for the drawbacks that are linked to the parasitic drag that is created.

This invention relates more specifically to the second family of air exhausts of the leveling type. Relative to the dynamic type exhausts, the exhausts of the leveling type generate a smaller surface defect and less of a parasitic drag.

However, this configuration is less capable in terms of differential head and thrust recovery to the extent that it is difficult to orient the exiting air in the direction of the outside air flow.

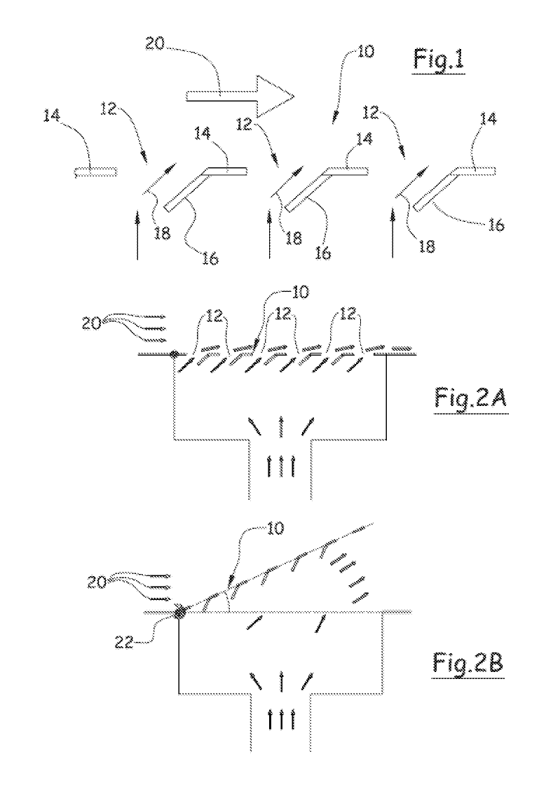

In general, an air exhaust of the leveling type is equipped with a grid as illustrated in FIG. 1 and described in the document FR20070052546. An air exhaust 10 in grid form comprises a number of rectangular-shaped openings 12 that are delimited by separating zones 14 that are arranged in the extension of the aerodynamic surface of the aircraft, whereby each opening 12 comprises a deflector 16 that is oriented toward the inside and inclined so as, on the one hand, to direct the exiting air that is indicated by the arrows 18 in a direction that is close to that of the outside air flow 20, and, on the other hand, to reduce the size of the surface defect.

According to a widespread embodiment, the air exhaust comprises several stages 22 of openings 12, whereby said stages are separated by at least one reinforcement or passage 24 that makes it possible to increase the mechanical characteristics of the grid.

These grid-type air exhausts make it possible to considerably reduce the surface defect. However, they are not satisfactory in terms of differential heads, which remain significant and which are a function of the surface of said exhaust.

According to another constraint, an air exhaust is to be sized for meeting the most important requirements that are those in the case of a malfunction, whose occurrence is rare. Consequently, an air exhaust is generally oversized to meet the requirements of a normal flight, which causes differential heads and additional surface defects that reduce the aerodynamic performance levels of the aircraft.

Also, this invention aims at eliminating the drawbacks of the prior art by proposing a grid-type air exhaust device that makes it possible to optimize the aerodynamic characteristics of said exhaust for normal flight conditions but meets the requirements in case of a malfunction.

For this purpose, the invention has as its object an air exhaust device that is equipped with a grid that is connected to an aerodynamic surface of an aircraft, whereby said grid comprises a number of openings delimited by separating zones that are arranged in the extension of the aerodynamic surface of the aircraft, whereby said device and grid are characterized by a surface that allows the passage of air, called a passage surface, characterized in that it comprises at least one movable part so as to increase the passage surface of the device, in particular in the case of a malfunction, and in that the grid has a passage surface that is determined based on the flow of air that is to be evacuated under the most restrictive conditions of a normal flight, in the absence of a malfunction.

This solution makes it possible to obtain a significant reduction of the surface area of the grid that is reflected by a reduction of the surface defects. In addition, whereby the shapes of the grid are determined based on a so-called normal operating speed in the absence of a malfunction, the differential heads are optimized for this operating speed and not for a rare speed such as a malfunction that leads to increasing the exhaust section covered by the grid.

Other characteristics and advantages will emerge from the following description of the invention, a description that is given only by way of example, taking into account the accompanying drawings, in which:

FIG. 1 is a cutaway of an air exhaust,

FIG. 2A is a cutaway that diagrammatically illustrates an air exhaust according to a first variant of the invention in a first state corresponding to normal flight conditions,

FIG. 2B is a cutaway that diagrammatically illustrates an air exhaust according to a first variant of the invention in a second state corresponding to an operation in the case of a malfunction,

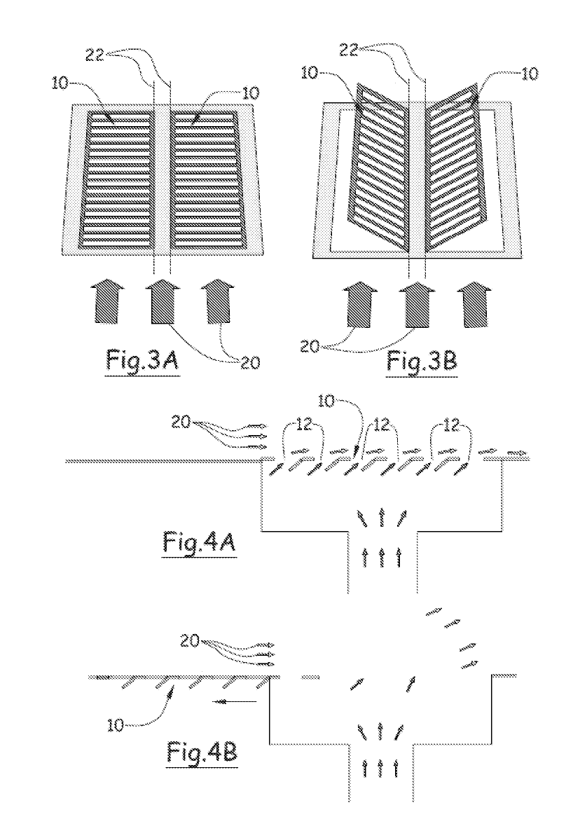

FIG. 3A is a perspective view of an air exhaust according to a second variant of the invention in a first state corresponding to normal flight conditions,

FIG. 3B is a perspective view of an air exhaust according to a second variant of the invention in a second state that corresponds to an operation in the case of a malfunction,

FIG. 4A is a cutaway that diagrammatically illustrates an air exhaust according to another variant of the invention in a first state corresponding to normal flight conditions, and

FIG. 4B is a cutaway that diagrammatically illustrates an air exhaust according to another variant of the invention in a second state that corresponds to an operation in the case of a malfunction.

In FIG. 1, an air exhaust device that comprises an opening or an exhaust that empties at an aerodynamic surface of an aircraft is shown in cutaway, whereby said exhaust is equipped with a grid 10 that is connected to said aerodynamic surface.

This grid can be provided at the nacelle, the fuselage, a mast or the wing. Nevertheless, other positions can be considered.

This air exhaust device can be integrated into one of the air systems of the aircraft, each comprising a circuit that extends from at least one air intake up to at least one air exhaust by passing through at least one exchanger or any other device that requires air or that operates with air, such as, for example, a heating, cooling or ventilation system. These air systems are not presented in more detail because they are known to one skilled in the art. Furthermore, the air exhaust device according to the invention is not limited to these applications and may be suitable for other circuits, other devices, or other air intakes.

According to one embodiment, a grid 10 comprises a number of openings 12 that are delimited by separating zones 14 that are arranged in the extension of the aerodynamic surface of the aircraft. Each opening 12 can comprise a deflector 16 that is oriented toward the inside and inclined so as, on the one hand, to direct the exiting air that is indicated by the arrows 18 in a direction that is close to that of the flow of outside air 20, and, on the other hand, to reduce the size of the surface defect.

As a variant, the grid 10 cannot comprise any deflector or deflectors in the form of articulated flaps along axes of rotation provided at one of the sides of the opening, in particular the one that is perpendicular to the outside air flow 20 and arranged downstream along this same flow 20. The movement of the flaps, in particular the opening of the flaps, can be controlled by any suitable means. To limit the surface defects, the openings have a narrow width.

To increase the mechanical and structural characteristics of the air exhaust 10, the latter can comprise at least one longitudinal reinforcement or passage that separates the openings into at least two stages. This or these passage(s) make(s) it possible to limit the height (direction perpendicular to the outside air flow 20) of the openings to limit the risks of flexion of the separating zones 14 that are provided between the openings of the same stage.

The exhaust device is characterized by a passage surface that corresponds to the surface that is detached from the exhaust that allows the passage of air, whereby said passage surface is determined based on in particular the flow of air that is to be evacuated. When the exhaust is sealed by a grid, the passage surface of the air exhaust device corresponds to the sum of the surfaces of the openings 12.

According to the invention, and contrary to the prior art, the passage surface of the grid is not determined based on the flow of air that is to be evacuated during a malfunction but on the flow of air that is to be evacuated under the most restrictive conditions of a normal flight in the absence of a malfunction.

By way of example, a pre-cooling system exhaust grid was sized according to the prior art for a case of a malfunction whose frequency is of a malfunction every 10,000 hours of flight. For a malfunction, the flow rate of air that is to be evacuated is on the order of 2.4 kg/s, which requires a passage surface on the order of 10 dm² or a grid surface area on the order of 43 dm².

In this case, according to the invention, the passage surface area is determined based on the flow rate of air that is to be evacuated for the most restrictive case of a normal flight, or a flow rate of the air that is to be evacuated of 1.9 kg/s. This flow rate requires a passage surface on the order of 4.2 dm², or a grid surface on the order of 20 dm².

A significant reduction of the surface area of the grid that is reflected by a reduction in surface defects is noted.

Whereby the shapes of the grid are determined based on a so-called normal operating speed in the absence of a malfunction, the differential heads are optimized for normal flight conditions in the absence of a malfunction.

To allow the passage of a more consistent air flow in the case of a malfunction, the exhaust comprises at least one movable part so as to modify the passage surface and to increase it in case of a malfunction or in the event of a specific need.

According to a specific embodiment, the exhaust can be blocked by the grid and by at least one movable part so as to make the passage surface of the exhaust vary, whereby said movable part is able to occupy a first state in which it at least partially detaches the exhaust, in particular in the case of a malfunction, to make possible the passage of a more significant flow rate of air that is to be evacuated and a second state in which it is arranged in the plane of the aerodynamic surface of the aircraft and at least partially blocks said exhaust.

Advantageously, the grid 10 or at least a portion of the grid 10 is movable to detach the exhaust at least partially. This solution makes it possible to obtain a more compact device to the extent that the cross-section of the exhaust corresponds to that approximately of the grid.

To simplify the explanations, the invention is described as applied to a movable grid. Of course, the given explanations can apply to a movable portion of the grid.

According to a first variant, the grid can pivot along a pivoting axis 22 that is arranged at the aerodynamic surface of the aircraft as illustrated in FIGS. 2A, 2B, 3A and 3B.

Thus, in the absence of a malfunction, the grid 10 is arranged in the extension of the aerodynamic surface of the aircraft as illustrated in FIGS. 2A and 3A. In the presence of a malfunction or in the event of a specific need, the grid 10 pivots so as to detach the exhaust as illustrated in FIGS. 2B and 3B, making possible the passage of a more significant flow rate of air.

The optimum angle of pivoting of the grid is on the order of 30°.

According to a first embodiment, the pivoting axis 22 is perpendicular to the direction of flow of outside air 20, as illustrated in FIGS. 2A and 2B. In this case, the pivoting axis 22 is preferably arranged at the upstream edge of the grid in the direction of flow of outside air. Thus, in the case of a malfunction, there is a dynamic-type air exhaust configuration that makes it possible to maximize the recovery of the thrust produced by the exiting air, which in the case of a malfunction has a significant flow rate, and to reduce the differential heads. Furthermore, this configuration makes it possible to generate a negative pressure at the exhaust that promotes the extraction of air.

According to another advantage of this configuration, it makes it possible to obtain a compact exhaust device.

According to another embodiment, the pivoting axis 22 is parallel to the direction of the outside air flow 20, as illustrated in FIGS. 3A and 3B.

According to another variant that is illustrated in FIGS. 4A and 4B, the grid 10 can move translationally between a first position that is illustrated in FIG. 4A in which it is arranged to the right of the opening and a second position that is illustrated in FIG. 4B in which it at least partially detaches the exhaust that makes possible the passage of a more significant air flow. According to the embodiment that is illustrated in FIGS. 4A and 4B, the grid can move translationally in the plane of the aerodynamic surface of the aircraft.

Actuators are provided to guide the movement of the grid or the portion of the grid, for example, struts, springs, or endless screws.

1. Air exhaust device that is equipped with a grid (10) that is connected to an aerodynamic surface of an aircraft, whereby said grid comprises a number of openings (12) that are delimited by separating zones (14) that are arranged in the extension of the aerodynamic surface of the aircraft, whereby said device and the grid are characterized by a surface that makes possible the passage of the air called passage surface, characterized in that it comprises at least one movable part so as to increase the passage surface of said device, in particular in the case of a malfunction, and in that the grid (10) has a passage surface that is determined as a function of the flow rate of air that is to be evacuated under the most restrictive conditions of a normal flight, in the absence of a malfunction.

2. Air exhaust device according to claim 1, wherein the grid (10) or at least a portion of the grid (10) is movable so as to occupy a first position that corresponds to the normal flight conditions in which said grid (10) or said at least one portion of the grid is arranged to the right of the exhaust in the extension of the aerodynamic surface of the aircraft and another corresponding position, in particular in the conditions of a malfunction, in which said grid (10) or said at least one portion of the grid (10) at least partially detaches the opening so as to increase the passage surface of said device.

3. Air exhaust device according to claim 2, wherein the grid (10) or at least a portion of the grid (10) can move translationally.

4. Air exhaust device according to claim 2, wherein the grid (10) or at least a portion of the grid (10) can pivot.

5. Air exhaust device according to claim 4, wherein the grid (10) or at least a portion of the grid (10) can pivot along a pivoting axis (22) that is parallel to the direction of the air flow (20) that flows outside of the aircraft.

6. Air exhaust device according to claim 4, wherein the grid (10) or at least a portion of the grid (10) can pivot along a pivoting axis (22) that is perpendicular to the direction of the air flow (20) that flows outside of the aircraft.

7. Air exhaust device according to claim 6, wherein the pivoting axis (22) is arranged at the upstream edge of the grid (10) in the direction of the air flow (20) flowing outside of the aircraft.

8. Air exhaust device according to claim 5, wherein the pivoting angle of the grid is on the order of 30°.

9. Aircraft that comprises an air exhaust device according to claim 1.

10. Air exhaust device according to claim 6, wherein the pivoting angle of the grid is on the order of 30°.

11. Air exhaust device according to claim 7, wherein the pivoting angle of the grid is on the order of 30°.
